(19) United States
(12) Patent Application Publication
(10) Pub. No.: US 2025/0136475 A1
(43) Pub. Date: May 1, 2025

(54) WATER PURIFICATION BY CAVITATION

(71) Applicant: ION SOURCE, LLC, Dallas, TX (US)

(72) Inventors: Nicholas Lloyd Holbrook, Dallas, TX (US); Gordon Winfrey, Bay City, TX (US); Joe Calvin Bradford, Houston, TX (US)

(21) Appl. No.: 18/932,647

(22) Filed: Oct. 31, 2024

Related U.S. Application Data
(60) Provisional application No. 63/595,246, filed on Nov. 1, 2023.

(51) Int. Cl. C02F 1/34; C02F 1/465

(52) U.S. Cl. CPC C02F 1/34; C02F 1/465; C02F 2201/002; C02F 2303/24

(57) ABSTRACT

Methods and apparatus for water purification. In at least one embodiment, the apparatus includes a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing. The solid plates substantially increase longevity and run-time of the cavitation apparatus, without sacrificing efficiency and effectiveness of contaminant separation from the water. The solid plates significantly reduce fatigue, improve run time and reduce wear and tear.

### BACKGROUND OF THE INVENTION

### Field of the Invention

Embodiments of the present invention generally relate to systems, apparatus and methods for water purification. More specifically, embodiments of the present invention relate to systems, apparatus and methods for water purification using cavitation.

### Description of the Related Art

Cavitation is a phenomenon that has been used to purify water. Cavitation occurs when the pressure of a liquid drops below its vapor pressure, causing the formation of vapor-filled cavities or bubbles, followed by the sudden collapse of those cavities or bubbles, creating energy. In the context of water purification, cavitation is typically acoustic cavitation and/or hydrodynamic cavitation. Acoustic and hydrodynamic cavitation are used in different water treatment systems depending on the specific requirements and conditions of the process. The choice of cavitation usually depends on factors such as the type and concentration of contaminants, flow rate, and the desired water quality outcome.

Acoustic cavitation is generated by ultrasonic waves and is sometimes known as sonochemical cavitation. When high-intensity ultrasound waves pass through a liquid, they create alternating high and low-pressure zones, leading to the formation and collapse of microscopic bubbles. These implosions generate high temperatures (e.g. >5,000° C.) and pressures (e.g. >1,000 bar), which can kill microorganisms, such as bacteria and viruses, present in the water.

Hydrodynamic cavitation is created by manipulating the flow of water through specially designed devices or nozzles. As water flows through these devices, pressure drops, and cavitation bubbles form. Similar to acoustic cavitation, hydrodynamic cavitation can be used to inactivate microorganisms in the water. Hydrodynamic cavitation also can be used to disperse oil or organic contaminants in water, making it easier to remove.

The collapse of cavitation bubbles is used to assist in chemical reactions or physical processes, like flocculation or precipitation, for the removal of impurities. The collapse of cavitation bubbles is also used to break down organic pollutants and contaminants in water through a process called sonolysis.

Another aspect of cavitation is the decomposition of water. Due to the high pressure and high temperature, the water molecules decompose into reactive hydrogen atoms and hydroxyl radicals that are capable of oxidation and reduction in the immediate vicinity of the bubble. During the collapse phase of the bubble, liquid vapor tends to condense at the bubble wall, and the vapor at the center of the bubble can become trapped in the bubble during the collapse when the temperatures and pressures inside the bubble are at the extreme. At these conditions the vapor inside the bubble can decompose to yield hydrogen (H+) and hydroxyl (OH) radicals, as well as hydrogen peroxide (H₂O₂), a strong oxidizing agent that is formed by the reaction of two hydroxyl radicals. These radicals mix with the bulk liquid when the bubble bursts during the transient collapse and can induce various chemical reactions that lead to degradation of organic pollutants.

Canadian publication document No CA2977259 describes a purification process that does not involve cavitation. Benzene, toluene, xylene, polycyclic aromatic hydrocarbons, and other hydrocarbon derivatives are removed in the process for removing oil derivatives. The solution is based on a composition that contains microorganisms, but does not contain solvents or toxic substances, and the components of which are capable of decomposing various hydrocarbon derivatives.

Chinese publication document No. CN102491553 describes a system and application method by which contaminated water from oil fields can be treated using cavitation. In the first part of the two-stage process, cavitation is used for separation, while in the second stage, the water undergoes a sterilizing treatment.

Chinese utility model application No CN204508849 describes a cavitation apparatus for purifying contaminated water and removing liquid organic matter. The apparatus includes a vortex pump and an ozone generator, and the rotating impeller of the pump creates cavitation bubbles in conical cavities along the wall of the apparatus.

Chinese patent description No. CN107344029 describes an apparatus for separating oil and water, which also uses cavitation for more thorough water purification. Oxidation bubbles are created in the apparatus; such bubbles are less than 200 nanometers in size, and they can adhere to oil contaminants and break up longer molecular chains of contaminants. The purification effect can be improved by using cavitation.

Chinese publication document No. CN106186179 describes a water purification system that is based on hydrodynamic cavitation. The system uses cavitation only; water is not treated with chemicals, so secondary contaminants can be avoided. Compared to conventional physical purification processes, the cavitation system according to the solution is simpler, more efficient, and inexpensive.

Russian publication document No RU2585635 describes a cavitation-based water purification and disinfection system. An oxygen-air mixture is injected into the cavitation space, and the medium to be cleaned is agitated by a rotating magnetic field, and then the medium is settled and the sludge contaminants are removed.

Ukrainian utility model application No UA63974 describes a process for the industrial treatment of contaminated water from mining; the process consists of several steps and is based on the phenomenon of cavitation. During water treatment, the contaminant molecules are destroyed and then isolated. As the number of cavitation bubbles increases, the water pressure decreases and a shock wave is created, which is used to purify the water.

Ukrainian utility model application No UA84014 also describes a cavitation-based water treatment apparatus. This equipment is also equipped with ozone generators.

Ukrainian utility model description No UA22956 describes a cavitation-based process for refining liquid hydrocarbons. During the process, liquid hydrocarbons, such as petroleum or oil derivatives, are mixed with water and absorbent catalysts, and then cavitation is used to separate hydrocarbons from water, hydrogen sulfide, and other materials.

U.S. Publication No. 2022/0234914A1 combines electrolysis and cavitation within a single housing. An electrical charge is applied to the rotating wheels within the cavitator housing.

U.S. Publication No. 2010/090124A1 combines an impeller induced cavitation and UV irradiation in a single reactor chamber. A rotary cavitator was arranged in the reactor chamber to cause cavitation in the fluid. The cavitation was also irradiated by static UV light, to aid in the further destruction of the pollutants. The energy consumption in such types of rotating cavitation is much higher and flexibility of the design parameters is low compared to cavitation reactors based on the use of orifice plates or venturis.

U.S. Publication No. 2013/248429A1 describes an apparatus for water purification in which contaminated water is treated using cavitation and ultraviolet light. Cavitation bubbles are created in the apparatus by rotatable plates with holes that are placed in the fluid flow. Irradiation with ultraviolet light is used to kill microbes (microorganisms).

U.S. Publication No. 2003/042174A1 describes a process in which various hydrocarbons are released from an emulsified hydrocarbon mixture by cavitation only, without any additional heating, catalysts and other auxiliaries. The high temperature and pressure caused by cavitation helps to break down the emulsion, and thus better quality petroleum products with lower emissions can be produced. The cavitation treatment of the emulsion can be performed in several cycles until the desired separation is achieved.

Slovenian patent document No SI24180 describes a water purification device that is based on the phenomenon of cavitation. In the apparatus, cavitation bubbles are created in the gaps between the stators and rotors, which destroy the structure of biological materials and thus purify the water.

There is still a need for a new system, apparatus and method that operate without harming the environment and can operate at higher efficiencies and lower costs.

### SUMMARY OF THE INVENTION

Systems, apparatus and methods for wastewater purification are provided herein. In at least one specific embodiment, the apparatus can include a housing, at least two solid plates disposed within the housing, at least one shaft for rotating the at least two solid plates, wherein the at least one shaft is at least partially located within the housing, and at least one motor for rotating the at least one shaft. The at least two solid plates can be independently rotated in opposite directions of one another to further enhance cavitation within the housing.

In at least one embodiment, the system includes a cavitator and one or more electrolytic cells in fluid communication with the cavitator. The cavitator includes a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing.

In at least one embodiment, the method includes introducing a waste stream comprising water and one or more contaminants to a cavitator, flowing an effluent from the cavitator to one or more electrolytic cells, the effluent comprising the water and a portion of the one or more contaminants from the waste stream; and recovering a purified water stream from the one or more electrolytic cells. In at least one specific embodiment, the cavitator includes a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing.

It has been unexpectedly and surprisingly discovered that solid plates substantially increase longevity and run-time of the cavitation apparatus, without sacrificing efficiency and effectiveness of contaminant separation from the wastewater. The solid plates significantly reduce fatigue, significantly improve run time and significantly reduce wear and tear.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein. It is to be noted, however, that the appended drawings illustrate only typical embodiments of this invention and are, therefore, not to be considered limiting of its scope, for the invention may admit to other equally effective embodiments. It is also emphasized that the figures are not necessarily to scale and certain features and certain views of the figures can be shown exaggerated in scale or in schematic for clarity and/or conciseness.

FIG. 1 depicts an illustrative schematic view of an apparatus for creating cavitation, according to one or more embodiments provided herein.

FIG. 2 depicts an illustrative side view of an inner surface of a solid plate, according to one or more embodiments provided herein.

FIG. 3 depicts an illustrative side view of an inner surface of a solid plate having a plurality of pins, according to one or more embodiments provided herein.

FIG. 4 depicts an illustrative schematic side view of two opposing solid plates, each plate having pins, where the opposing pins at least partially overlap one another, according to one or more embodiments provided herein.

FIG. 5 depicts an illustrative schematic side view of two opposing solid plates, each plate having pins with apertures formed therethrough, the opposing pins at least partially overlapping, according to one or more embodiments provided herein.

FIG. 6 depicts an illustrative system for purifying water using the apparatus 100, according to one or more embodiments provided herein.

### DETAILED DESCRIPTION

An apparatus, method and system for water purification are provided. The method and system utilize a new apparatus for creating cavitation. The apparatus includes a housing that contains at least two disks or plates that are rotatable within the housing. At least one shaft can be used to rotate the plates, although two different shafts are preferred, one shaft for each plate. The shaft(s) can be at least partially located within the housing, and mechanically linked to a motor. At least one motor can be used for rotating each shaft, or a single motor can be used to rotate more than one shaft. The plates are solid and preferably made from any suitable metal or metal alloy. The solid plates significantly reduce fatigue and significantly improve run time and reduce wear and tear. Another significant advantage of the cavitation device provided herein is that that the device can be located on site, meaning wherever wastewater is generated and/or wherever contaminated water is found, such as for example, at a well site, drill site, lake, river, ocean, other bodies of water, and remote areas.

A more detailed description of the invention provided herein will now be provided. The present invention will be described in connection with numerous embodiments. Such discussion is for purposes of illustration only and not intended to be limitative of the invention. Modifications to particular embodiments within the spirit and scope of the present invention, set forth in the appended claims, will be readily apparent to those of skill in the art. Accordingly, it is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention.

The scope of the invention is defined by the appended claims. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

Additionally, the present disclosure can repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows can include embodiments in which the first and second features are formed in direct contact and can also include embodiments in which additional features can be formed interposing the first and second features, such that the first and second features cannot be in direct contact. The exemplary embodiments presented below also can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case, does not include any other component to a level greater than 3 wt %.

Moreover, certain embodiments and features will be described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. And unless otherwise indicated, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

In the following discussion and in the claims, the singular forms “a”, “an”, and “the” are intended to include the plural forms as well, unless the context clearly indicates otherwise. The term “or” is intended to encompass both exclusive and inclusive cases, i.e., “A or B” is intended to be synonymous with “at least one of A and B,” unless otherwise expressly specified herein.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

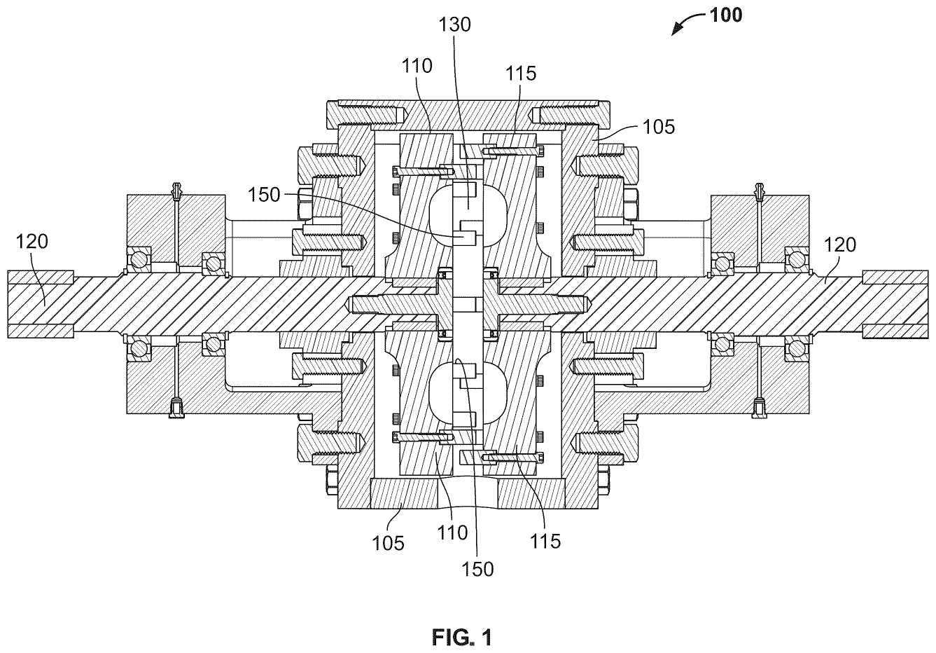

FIG. 1 depicts an illustrative schematic view of an apparatus 100 for creating cavitation, according to one or more embodiments provided herein. The apparatus 100 can include a casing or housing 105 that contains at least two solid disks or plates 110, 115 that are rotatable therein. At least one shaft 120 can be used to rotate the solid plates 110, 115, although two different shafts 120 are preferred, one shaft for each plate. The shaft(s) 120 can be at least partially located within the housing 105, and mechanically linked to a motor (not shown). At least one motor can be used for rotating each shaft, or a single motor can be used to rotate more than one shaft.

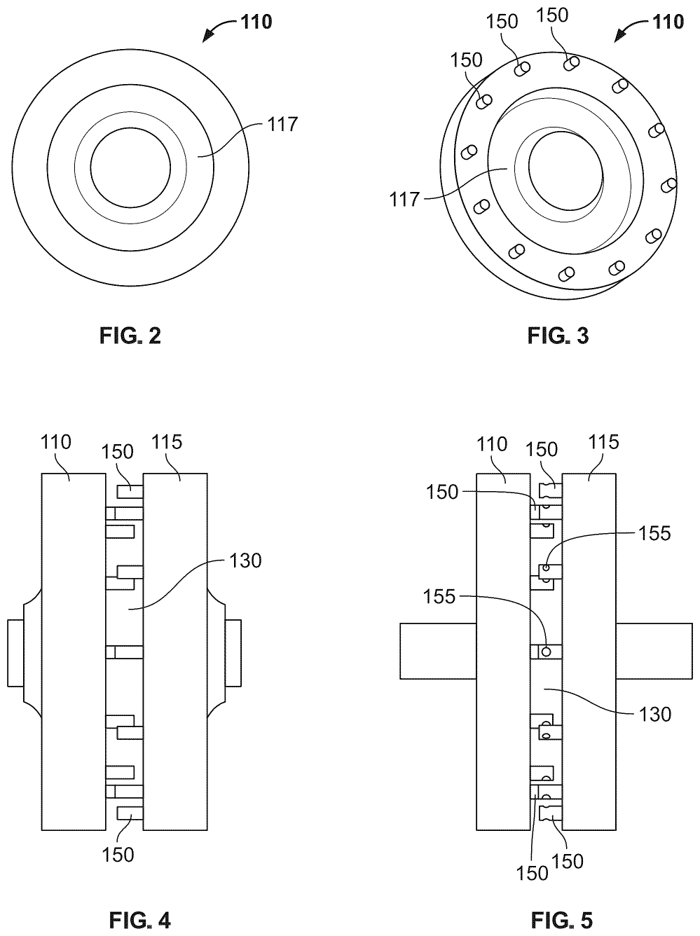

FIG. 2 depicts an illustrative side view of an inner surface 117 of a solid plate 110, 115 according to one or more embodiments provided herein. Although not shown, the back side or outer surface of the solid plate 110, 115 is the same. FIG. 3 depicts another embodiment of a solid plate 110, 115 that can be used. FIG. 3 depicts an illustrative side view of an inner surface 117 of a solid plate 110, 115 having a plurality of pins 150, according to one or more embodiments provided herein. By “solid” it is meant that that the plates 110, 115 have no spokes, holes or other openings formed therethrough other than optionally a single central opening or hub for connecting to the mechanical shaft 120 configured to rotate the plate 110, 115 within the housing 105. In certain embodiments, the mechanical shaft 120 can be mechanically linked or connected to the plates 110, 115 without the need for a centrally located opening or hub in the plates 110, 115, such as a direct weld, magnet, or other suitable form of connection.

One or both solid plates 110,115 can include a plurality of extensions, protrusions or pins 150 disposed on the inner surface 117 thereof, the outer surface thereof, or both surfaces. Both plates 110, 115 can include said pins 150. By “plurality of pins”, it is meant two or more, three or more, four or more, five or more, ten or more, twelve or more, fifteen or more, or twenty or more. The number of pins 150 can be the same or different on each plate 110, 115. For example, the number of pins 150 on each plate 110, 115 can range from 2, 3, or 5 to 10, 15, or 20. In other embodiments, each plate 110, 115 can have 4-30 pins; 12-25 or 14-22 pins.

Different shapes and sizes of pins can be used. For example, the cross-sectional profile of each pin 150 can be the same or different and can be square, rectangular, circular, elliptical, or oval shaped. Each pin 150 can have any cross-sectional profile and any combination of profiles can be used. Moreover, the outer end or distal end of each pin 150 can be flat, rounded, or chamfered.

The width of each pin 150 can be the same or different. Likewise, the length of each pin can be the same or different. The width of each pin (i.e. diameter if pin is round) can vary between a low of about 0.1 mm, 0.3 mm, or 0.5 mm to a high of about 10 mm, 30 mm or 50 mm. The length of each pin can vary between a low of about 0.5 mm, 1.0 mm, or 2.0 mm to a high of about 10 mm, 250 mm or 100 mm. In certain embodiments, the length and/or diameter of the pins 150 on both plates 110, 115 are all the same. In certain embodiments, the length and/or diameter of the pins 150 on both plates 110, 115 can vary. For example, in certain embodiments, the length and/or diameter of the pins 150 on one plate 110 or 115 are all the same, but different than the length and/or diameter of the pins 150 on the other plate 110, 115. In certain embodiments, the length and diameter of the pins 150 on one plate 110 or 115 are the same as the length and diameter of the pins 150 on the other plate 110, 115. In certain embodiments, the length of the pins 150 on one plate 110 or 115 are the same as the length of the pins 150 on the other plate 110, 115. In certain embodiments, the diameter of the pins 150 on one plate 110 or 115 are the same as the diameter of the pins 150 on the other plate 110, 115. In certain embodiments, the length of the pins 150 on one plate 110 or 115 are the same, but are longer or shorter than the length of the pins 150 on the other plate 110, 115. In certain embodiments, the diameter of the pins 150 on one plate 110 or 115 are the same but is large or smaller than the diameter of the pins 150 on the other plate 110, 115. In certain embodiments, the length of the pins 150 on one plate 110 or 115 are varied, and the length of the pins 150 on the other plate 110, 115 are the same. In certain embodiments, the diameter of the pins 150 on one plate 110 or 115 are varied, and the diameter of the pins 150 on the other plate 110, 115 are the same. In certain embodiments, the diameter of the pins 150 on both plates 110, 115 are varied, and the length of the pins 150 on both plates 110, 115 are the same. In certain embodiments, the length of the pins 150 on both plates 110, 115 are varied, and the diameter of the pins 150 on both plates 110, 115 are the same.

Referring again to FIG. 1, two solid plates 110, 115 can be used and the two solid plates 110, 115 are rotated in opposite directions of one another. The two plates 110, 115 can be disposed opposite of one another, within the housing 105, defining a void space or cavity 130 therebetween. In this configuration, the inner surface 117 of each plate 110, 115 face one another and the outer surfaces of each plate face the surrounding housing 105. In another embodiment, one or both plates 110, 115 can include a plurality of pins 150 arranged about the inner surface 117 thereof, such the pins 150 are located within the cavity 130 of the housing 105. The size or volume of the cavity 130 between the plates 110, 115 can vary depending on the size of the plates 110, 115, the number of pins 150, the spacing between the housing 105 and the plates 110, 115, or any combination thereof. A fluid inlet (not shown) can be located anywhere about the housing 105. In one embodiment, for example, the fluid inlet (not shown) is centrally located about the housing between the plates 110, 115.

FIG. 4 depicts an illustrative schematic side view of two opposing solid plates 110, 115, both having pins 150, and the surrounding housing 105 removed. In this embodiment, the two opposing solid plates 110, 115 both have pins 150 and are arranged such that the opposing pins 150 at least partially overlap one another within the cavity 130. The degree of overlap within the cavity 130 can vary. For example, the degree of overlap can range from about 3%, 5%, or 10% to about 20%, 50%, or 99% of the length of the pin. The degree of overlap also can be about 3%, 5%, 10%, 20%, 30%, 50%, 60%, 70%, 80%, 90%, 95%, or 99% of the length of the pin.

Each pin 150 can be solid or can have at least one opening, bore, hole or aperture 155 formed therethrough. FIG. 5 depicts an illustrative schematic side view of two opposing solid plates 110, 115, each plate having pins 150 with apertures 155 formed therethrough, the opposing pins 150 at least partially overlapping, according to one or more embodiments provided herein. When present, the aperture 155 can be located more toward the distal end of the pin 150 or about the mid-point of the pin 150. The apertures 155 are believed to create additional pressure drop within the cavity 130, thereby increasing turbulence and cavitation. Pins 150 with apertures 155 can be randomly distributed about the inner surfaces 117 of one or both plates 110, 115. Alternatively, any pattern or frequency of pins 150 with apertures 155 can be used in combination with solid pins 150, such as every other pin, every three pins, along the periphery only, closest to the center, or the like.

In operation, each plate can be rotated at about 1,000 to about 5,000 RPMs. The temperature within the housing can range from about 0° C. to about 150° C. and the pressure can range from 1 bar to about 20 bar.

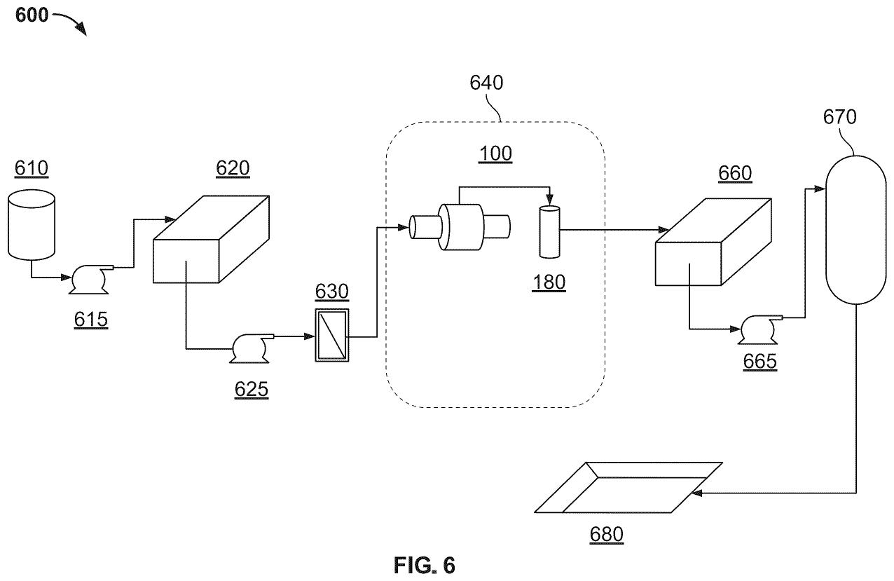

FIG. 6 depicts an illustrative system for purifying water using the cavitation apparatus 100, according to one or more embodiments provided herein. The system 600 can include one or more raw water tanks 610 for storing the wastewater to be purified. One or more pumps 615 can be used to transfer the water from the tank 610 through one or more separators 620. One or more transfer pumps 625 can be used to transfer the separated water from the separator(s) 620 through one or more strainers 630 to one or more cavitation apparatus 100, as described herein. Water exiting the one or more cavitation apparatus 100 can then pass through one or more electrolytic cells 180, followed by additional separation within one or more separators 660 and then pumped via one or more pumps 665 to one or more storage tanks 170 and/or holding ponds 680.

The source of the wastewater can vary and can be a mixture or combination of many different sources. The water can derive from municipal sewage, sanitation, farming operations, oil and gas operations, metal mining operations, rain runoff, and/or cooling towers, for example. Specific examples of wastewater derived from oil and gas operations include water flooding, produced water and/or frac water. The wastewater also can be any kind of gray water, brine, brackish or saltwater, including industrial, municipal, agricultural, and oilfield wastewaters.

In certain embodiments, the wastewater can contain water that is contaminated with one or more volatile compounds, or odorants, such as ammonia, acetone, methylethylketone (MEK), and/or volatile organic compounds (VOCs), such as benzene, toluene and xylene. The wastewater can also contain one or more dissolved noncondensable gases, including hydrogen sulfides (H2S, commonly known as sewer gas), chlorine (Cl2), ammonia (NH3), methane (CH4), nitrous oxide (N2O), and/or nitrogen (N2). The wastewater can also contain one or more dissolved liquids and/or solids typically found in municipal sewage and/or farming operations, including ammonia and other nitrogen containing compounds, lead, iron, sulfates, sulfites, ammonia, methane, sulfur and the like. The wastewater can also contain one or more dissolved liquids and/or solids, typically derived from downhole operations, such as hydrocarbons, oils, lubricants, surfactants, emulsifiers, drilling muds, frac fluids, and other chemicals used for oil and gas drilling, fracing and production. The wastewater can also contain one or more dissolved solids and/or minerals typically derived from mining operations, including iron, magnesium, calcium, chromium, lithium, cobalt, nickel, gold, silver, titanium, tin, lead, aluminum, gallium, indium, among others. The wastewater can also contain one or more dissolved liquids and/or solids, typically derived from pulp and paper operations, wood drying operations, as well as distilled liquor processes.

Still referring to FIG. 6, the one or more separators 620, 660 can be any conventional type of gravity separators, screens, membranes or the like. The purpose of the separators 620, 660 is to remove any solid particles, such as clay, minerals, metal, plastics, flocculants, or other solid formations, from the water, as well as any fluids, such as hydrocarbons, oil, diesel, gasoline, lubricants, grease, fats, polymers or other fluids having a density less than water. Similarly, the one or more strainers 630 can be any conventional screen or membrane for removing smaller particulates from the water that pass by the separators 620, 660.

Any conventional electrolysis cell or device 180 can be used. A suitable electrolytic cell 180 can include two solid metal electrodes, namely an anode and a cathode, that are connected to an external source of electricity. The anode is connected to the positive terminal and the cathode is connected to the negative terminal of the electrical source. At the anode, an oxidation reaction takes place, while a reduction reaction takes place at the cathode. For example, the electrolytic cell 180 can provide a catalytic reaction to convert any chlorine ions from the water into free chlorine and chlorine dioxide. Cations such as iron and aluminum are positively charged and can enable Fenton-like reactions. The Fenton reaction is the reaction between iron and hydrogen peroxide, generating hydroxyl radicals, which can be used to kill and bacteria or other biological impurities in the water.

From the electrolytic cell 180, the water is then passed through a second filtration system/separators 660 to further remove any suspended solids. The filtration system/separators 660 can include any one of or any combination of a cartridge, media or membrane, reverse osmosis, and ion exchange to further purify the water that is then pumped to the storage tank 670 and/or a holding pond 680. Although not shown, the cleaned or purified water can be discarded in surrounding tributaries, lakes, ponds or other bodies of water.

The present invention further includes any one or more of the following specific embodiments listed below.

Embodiment 1: An apparatus for creating cavitation, comprising: a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing.

Embodiment 2: The apparatus according to embodiment 1, wherein at least one solid plate comprises a plurality of pins disposed on an outer surface thereof.

Embodiment 3: The apparatus according to embodiments 1 or 2, wherein each solid plate comprises a plurality of pins disposed on an outer surface thereof, and when the solid plates are disposed opposite one another so that the pins at least partially overlap.

Embodiment 4: The apparatus according to embodiments 2 or 3, wherein at least one of the plurality of pins comprises at least one aperture formed therethrough.

Embodiment 5: The apparatus according to any embodiment 2 to 4, wherein each pin comprises at least one aperture formed therethrough.

Embodiment 6: The apparatus according to any embodiment 2 to 5, wherein each pin is solid.

Embodiment 7: The apparatus according to any embodiment 2 to 6, wherein the plurality of pins comprises a combination of solid pins and pins comprising at least one aperture formed therethrough.

Embodiment 8: The apparatus according to any embodiment 1 to 7, wherein one solid plate comprises a plurality of pins disposed on an outer surface thereof and the other solid plate has no pins.

Embodiment 9: The apparatus according to embodiment 8, wherein the pins are solid.

Embodiment 10: The apparatus according to embodiment 8 or 9, wherein at least one of the pins comprises at least one aperture formed therethrough.

Embodiment 11: The apparatus according to any embodiments 2 to 10, wherein the plurality of pins comprises at least one solid pin and at least one pin having at least one aperture formed therethrough.

Embodiment 12: The apparatus according to any embodiment 2 to 11, wherein each pin is a cylindrical body extending from the at least one solid plate, and wherein an outer end of the cylindrical body is rounded or chamfered.

Embodiment 13: The apparatus according to any embodiment 2 to 12, wherein each pin is removably disposed on the outer surface of the at least one solid plate.

Embodiment 14: The apparatus according to any embodiment 2 to 13, wherein each pin has a length and diameter that is the same or different from another.

Embodiment 15: The apparatus according to any embodiment 2 to 14, wherein at least one pin of the plurality of pins has a length or diameter that is different from the other pins.

Embodiment 16: A system for wastewater purification, comprising: a cavitator comprising: a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing; and one or more electrolytic cells in fluid communication with the cavitator housing.

Embodiment 17. The system according to embodiment 16, wherein each solid plate comprises a plurality of pins disposed on an outer surface thereof, and when the solid plates are disposed opposite one another so that the pins at least partially overlap.

Embodiment 18. A method for wastewater purification, comprising: introducing a waste stream comprising water and one or more contaminants to a cavitator, the cavitator comprising: a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing; flowing an effluent from the cavitator housing to one or more electrolytic cells, the effluent comprising the water and a portion of the one or more contaminants from the waste stream; and recovering a purified water stream from the one or more electrolytic cells.

Embodiment 19. The method according to embodiment 18, wherein each solid plate comprises a plurality of pins disposed on an outer surface thereof, and when the solid plates are disposed opposite one another so that the pins at least partially overlap.

Embodiment 20. The method according to embodiments 18 or 19, wherein the one or more contaminants in the waste stream comprises one or more dissolved solids, and wherein the one or more dissolved solids are removed from the water within the cavitator housing.

### EXAMPLES

The foregoing discussion can be further described with reference to the following non-limiting examples.

### Example 1: Simulated

A simulation of a wastewater purification derived from a downhole fracing operation using a cavitator, as depicted in FIG. 1, with solid plates (“Ex. 1”) is compared to spoked plates with 4 spoke arms (i.e. in a +formation), as disclosed in US Publication 2022/0234914A1 (“Comp. Ex. 1”). The wastewater operating conditions for each simulation are summarized in Table 1 below.

TABLE 1
Wastewater Conditions

| | | |
|---|---|---|
| Flow Rate | 4,000 | bpd |
| Fluid Temperature | 90° | C. |
| Saturation Pressure | 70 | kPa |
| Fluid Density | 1,115 | kg/m³ |
| Fluid Dynamic Viscosity | 0.0012 | Pa-s |

In both simulations, the two disks rotated in opposite directions. The first disk (“Disk-1”) rotated in the opposite direction of the inlet flow into the housing and the second disk (“Disk-2”) rotated, opposite of the first disk, in the direction of the outlet flow from the housing. The cavitation volume is 1.398 in³ in both simulations. All disks were simulated with 12 identical pins, evenly distributed about the inner, opposing surface of the disks.

Table 2 below summarizes the simulation inputs and outputs:

| | Simulation Input | | | | Simulation Output | | |
|---|---|---|---|---|---|---|---|
| | | | | Satu- | | | Cavi- |
| | | Fluid | Mass | ration | Inlet | Outlet | tation |
| Config- | | Temp | Flow | Pressure | Pres | Pres | Volume |
| uration | RPM | [° F.] | [bpd] | [psi] | [psi] | [psi] | [in³] |
| Comp. Ex. 1 | 1,560 | 194 | 4,000 | 10.2 | 7.1 | 1.7 | 1.4 |
| Ex. 1 | 1,200 | 194 | 4,000 | 10.2 | 6.3 | 1.8 | 1.1 |

Table 3 shows the torque and force on each disk and Table 4 summarizes the stress and fatigue factors on the disks. Torque is measured about the x-axis which is along the disk shaft. The forces in the y-direction and z-direction were negligible. As shown, the torque and force acting on the solid disks of Ex. 1 are significantly less compared to the spoked configuration of Comp. Ex. 1.

TABLE 3
Torque and Load Comparison

| | Comp. Ex. 1 | | Ex. 1 | |
|---|---|---|---|---|
| | Torque [N m] | Fx [N] | Torque [N m] | Fx [N] |
| Disk-1 | −70 | −1,523 | −40 | −364 |
| Disk-2 | 94 | 1,040 | 52 | 282 |

TABLE 4
Summary of stress and fatigue factors

| Parameter | Comp. Ex1 | Ex. 1 | Notes |
|---|---|---|---|
| Natural frequency [Hz] | 259 | 453 | First bending/rocking mode |
| Stress [MPa] | 95.7 | 9.19 | Under equivalent loading for |
| | | | 0.05 mm max. deflection |
| Stress [MPa] | 1,310 | 131 | Under worst case scenario |
| Stress [MPa] | ~580 | ~58 | Based on 3-spoked reactor |
| | | | service life of 270,000 BBLs |
| Fatigue life [cycles] | 3.64E+09 | “Infinite” | Based on assumed 3-spoke |
| | | | baseline service life/history. |
| RPM | 1,560 | 1,255 | Less excitation cycles for the |
| | | | same life period |
| Peak surface pressure [MPa] | 0.29 | 0.19 | Reduced excitation magnitude |
| Cavitation volume | 1.398 | 1.398 | RPM directly drives cavitation |
| | | | volume |

### Example 2

In Example 2, an actual (non-simulated) cavitator as described with reference to FIG. 1 herein, equipped with two solid plates each having 12 evenly distributed, identical pins was operated for two months, continuously, to purify a 4,000 bpd wastewater stream summarized in Table 5 below. The wastewater was derived from a fracing operation in New Mexico. The disks were rotated at about 1200 rpms for about 2 months, without interruption.

Table 5 below shows the pH and composition of the water entering the cavitator and after two months of continuous operation, the pH and composition of the water exiting the cavitator.

TABLE 5
Water inlet and outlet summary.

| | | After 2 months | |
|---|---|---|---|
| Water entering | | water exiting | |
| pH | 6.86 | pH | 6.4 |
| Ca, mg/L | 2380 | Ca, mg/L | 806 |
| Mg, mg/L | 1613 | Mg, mg/L | 898 |
| Fe, mg/L | 1.6 | Fe, mg/L | 0.317 |
| Mn, mg/L | 0.709 | Mn, mg/L | 0.218 |
| Na, mg/L | 34830 | Na, mg/L | 13758 |
| K, mg/L | 1227 | K, mg/L | 778 |
| Ba, mg/L | 2.2 | Ba, mg/L | 1.011 |
| Sr, mg/L | 57.9 | Sr, mg/L | 14.9 |
| Sulfates, mg/L | 2900 | Sulfates, mg/L | 980 |
| Chlorides, mg/L | 61055 | Chlorides, mg/L | 25122 |
| B, mg/L | 678 | B, mg/L | 466 |
| Bicarbonate, mg/L | 488 | Bicarbonate, mg/L | 292 |
| H2S, mg/l | 136 | H2S, mg/l | 17 |
| Iron Sulfide, mg/l | 6.279 | Iron Sulfide, mg/l | 0.608 |
| Turbidity, NTU | 100 | Turbidity, NTU | 10 |
| Temperature, ° F. | 75 | Temperature, F. | 75 |
| Conductivity, mg/L | 75967 | Conductivity, mg/L | 53358 |
| TDS, mg/L | 105234 | TDS, mg/L | 46564 |
| Flowrate, bpd | 4,000 | Flowrate, bpd | 4,000 |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

What is claimed is:

1. An apparatus for cavitation, comprising:
a housing;
at least two solid plates disposed within the housing;
at least one shaft for rotating the at least two solid plates, wherein the at least one shaft is at least partially located within the housing; and
at least one motor for rotating the at least one shaft,
wherein the at least two solid plates are independently rotated in opposite directions of one another to further enhance cavitation within the housing.

2. The apparatus of claim 1 wherein at least one solid plate comprises a plurality of pins disposed on an outer surface thereof.

3. The apparatus of claim 1 wherein each solid plate comprises a plurality of pins disposed on an outer surface thereof, and when the solid plates are disposed opposite one another so that the pins at least partially overlap.

4. The apparatus of claim 2 wherein at least one of the plurality of pins comprises at least one aperture formed therethrough.

5. The apparatus of claim 2 wherein each pin comprises at least one aperture formed therethrough.

6. The apparatus of claim 2 wherein each pin is solid.

7. The apparatus of claim 2 wherein the plurality of pins comprises a combination of solid pins and pins comprising at least one aperture formed therethrough.

8. The apparatus of claim 1 wherein one solid plate comprises a plurality of pins disposed on an outer surface thereof and the other solid plate has no pins.

9. The apparatus of claim 8 wherein the pins are solid.

10. The apparatus of claim 8 wherein at least one of the pins comprises at least one aperture formed therethrough.

11. The apparatus of claim 8 wherein the plurality of pins comprises at least one solid pin and at least one pin having at least one aperture formed therethrough.

12. The apparatus of claim 2 wherein each pin is a cylindrical body extending from the at least one solid plate, and wherein an outer end of the cylindrical body is rounded or chamfered.

13. The apparatus of claim 2 wherein each pin is removably disposed on the outer surface of the at least one solid plate.

14. The apparatus of claim 2 wherein each pin has a length and diameter that is the same or different from another.

15. The apparatus of claim 2 wherein at least one pin of the plurality of pins has a length or diameter that is different from the other pins.

16. A system for wastewater purification, comprising:
a cavitator comprising: a housing; at least two solid plates disposed within the housing; at least one shaft for rotating the at least two solid plates, wherein the at least one shaft is at least partially located within the housing; and at least one motor for rotating the at least one shaft, wherein the at least two solid plates are independently rotated in opposite directions of one another to further enhance cavitation within the housing; and
one or more electrolytic cells in fluid communication with the cavitator housing.

17. The system of claim 16, wherein each solid plate comprises a plurality of pins disposed on an outer surface thereof, and when the solid plates are disposed opposite one another so that the pins at least partially overlap.

18. A method for wastewater purification, comprising:
introducing a waste stream comprising water and one or more contaminants to a cavitator, the cavitator comprising:
a housing;
at least two solid plates disposed within the housing;
at least one shaft for rotating the at least two solid plates, wherein the at least one shaft is at least partially located within the housing; and
at least one motor for rotating the at least one shaft, wherein the at least two solid plates are independently rotated in opposite directions of one another to further enhance cavitation within the housing;
flowing an effluent from the cavitator housing to one or more electrolytic cells, the effluent comprising the water and a portion of the one or more contaminants from the waste stream; and
recovering a purified water stream from the one or more electrolytic cells.

19. The method of claim 18, wherein each solid plate comprises a plurality of pins disposed on an outer surface thereof, and when the solid plates are disposed opposite one another so that the pins at least partially overlap.

20. The method of claim 18, wherein the one or more contaminants in the waste stream comprises one or more dissolved solids, and wherein the one or more dissolved solids are removed from the water within the cavitator housing.
